(19) United States
(12) Patent Application Publication
(10) Pub. No.: US 2025/0353004 A1
(43) Pub. Date: Nov. 20, 2025

(54) FLOW CELL ASSEMBLIES AND RELATED SYSTEMS AND METHODS

(71) Applicant: ILLUMINA, INC., San Diego, CA (US)

(72) Inventors: Sanket Rathore, San Diego, CA (US); David Kaplan, Carlsbad, CA (US); Jay Taylor, San Diego, CA (US); Jacob Ruden, San Diego, CA (US)

(21) Appl. No.: 18/851,599

(22) PCT Filed: Dec. 15, 2023
(86) PCT No.: PCT/US23/84196

§ 371 Date: Sep. 26, 2024

Related U.S. Application Data
(60) Provisional application No. 63/434,851, filed on Dec. 22, 2022.

(51) Int. Cl. B01L 3/00

(52) U.S. Cl. CPC B01L 3/502715; B01L 2200/025; B01L 2200/027; B01L 2200/028; B01L 2300/041; B01L 2300/047; B01L 2300/0609; B01L 2300/0816; B01L 2300/087; B01L 2300/0887; B01L 2400/0487

(57) ABSTRACT

Flow cell assemblies and related systems and methods are disclosed. An apparatus includes a flow cell assembly having a body, a first laminate, a second laminate, and a flow cell. The body carries a flow cell inlet gasket, a flow cell outlet gasket, and an outlet gasket. The body includes a fluidic aperture. The first laminate is coupled to the body and forms a first fluidic channel between the flow cell outlet gasket and the fluidic aperture. The second laminate is coupled to the body and forms a second fluidic channel between the fluidic aperture and the outlet gasket. The flow cell is supported by the body and includes a channel having a flow cell inlet and a flow cell outlet. The flow cell inlet is fluidly coupled to the flow cell inlet gasket and the flow cell outlet is fluidly coupled to the flow cell outlet gasket.

### RELATED APPLICATION

This application claims the benefit of and priority to U.S. Provisional Patent Application No. 63/434,851, filed Dec. 22, 2022, the content of which is incorporated by reference herein in its entirety and for all purposes.

### BACKGROUND

Sequencing platforms may use flow cell assemblies when performing different processes.

### SUMMARY

Advantages over the prior art and benefits as described later in this disclosure can be achieved through the provision of flow cell assemblies and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a system, a liquid reservoir, a cartridge assembly, and a flow cell assembly. The system includes a pneumatic interface and a receptacle and the liquid reservoir is receivable within the receptacle and has a body including a storage chamber, a pneumatic port fluidly couplable to the storage chamber, and a fluidic port fluidly coupled to the storage chamber. The cartridge assembly includes a fluidic interface couplable to the fluidic port, a well, a channel fluidly coupled between the fluidic interface and the well, and an outlet port fluidly coupled to the well. The flow cell assembly includes a body, a first laminate, a second laminate, and a flow cell. The body carries a flow cell inlet gasket, a flow cell outlet gasket, an outlet gasket and includes a fluidic aperture. The first laminate is coupled to the body and forms a first fluidic channel between the flow cell outlet gasket and the fluidic aperture and the second laminate is coupled to the body and forms a second fluidic channel between the fluidic aperture and the outlet gasket. The flow cell is supported by the body and includes a channel having a flow cell inlet and a flow cell outlet. The flow cell inlet is fluidly coupled to the flow cell inlet gasket and the flow cell outlet is fluidly coupled to the flow cell outlet gasket. The outlet port is fluidly coupled to the flow cell inlet gasket.

In accordance with a second implementation, an apparatus includes a cartridge assembly and a flow cell assembly. The cartridge assembly includes a fluidic interface, a well, a channel fluidly coupled between the fluidic interface and the well, and an outlet port fluidly coupled to the well. The flow cell assembly includes a body, a first laminate, a second laminate, and a flow cell. The body carries a flow cell inlet gasket, a flow cell outlet gasket, and an outlet gasket. The body includes a fluidic aperture. The first laminate is coupled to the body and forms a first fluidic channel between the flow cell outlet gasket and the fluidic aperture. The second laminate is coupled to the body and forms a second fluidic channel between the fluidic aperture and the outlet gasket. The flow cell is supported by the body and includes a channel having a flow cell inlet and a flow cell outlet. The flow cell inlet is fluidly coupled to the flow cell inlet gasket and the flow cell outlet is fluidly coupled to the flow cell outlet gasket. The outlet port is fluidly coupled to the flow cell inlet gasket.

In accordance with a third implementation, an apparatus includes a flow cell assembly having a body, a first laminate, a second laminate, and a flow cell. The body carries a flow cell inlet gasket, a flow cell outlet gasket, and an outlet gasket. The body includes a fluidic aperture. The first laminate is coupled to the body and forms a first fluidic channel between the flow cell outlet gasket and the fluidic aperture. The second laminate is coupled to the body and forms a second fluidic channel between the fluidic aperture and the outlet gasket. The flow cell is supported by the body and includes a channel having a flow cell inlet and a flow cell outlet. The flow cell inlet is fluidly coupled to the flow cell inlet gasket and the flow cell outlet is fluidly coupled to the flow cell outlet gasket.

In accordance with a fourth implementation, a method includes coupling a flow cell inlet gasket, a flow cell outlet gasket, and an outlet gasket with a body of a flow cell assembly. The body includes a fluidic aperture. The method includes coupling a first laminate to the body and forming a first fluidic channel between the flow cell outlet gasket and the fluidic aperture. The method also includes coupling a second laminate to the body to form a second fluidic channel between the fluidic aperture and the outlet gasket and coupling a flow cell and the body. The flow cell includes a channel having a flow cell inlet and a flow cell outlet. The flow cell inlet is fluidly coupled to the flow cell inlet gasket and the flow cell outlet is fluidly coupled to the flow cell outlet gasket.

In accordance with a fifth implementation, an apparatus includes a cartridge assembly, a first flow cell assembly including a first flow cell, and a second flow cell assembly including a second flow cell being different than the first flow cell. The first flow cell assembly and the second flow cell assembly are interchangeably mechanically and fluidly couplable with the cartridge assembly.

In accordance with a sixth implementation, an apparatus includes a cartridge assembly, a first flow cell assembly including a single flow cell, and a second flow cell assembly including a pair of flow cells. The first flow cell assembly and the second flow cell assembly are interchangeably mechanically and fluidly couplable with the cartridge assembly.

In accordance with a seventh implementation, a method includes flowing a liquid under positive pressure into a well of a cartridge assembly including dry reagent to rehydrate the dry reagent. The cartridge assembly includes the well and an outlet port fluidly coupled to the well. The method also includes flowing the rehydrated reagent into a flow cell inlet gasket of a flow cell assembly using a pump. The flow cell assembly includes a body carrying the flow cell inlet gasket and a flow cell supported by the body, the flow cell inlet gasket fluidly coupled to the outlet port and the flow cell.

In further accordance with the foregoing first, second, third, fourth, fifth, sixth, and/or seventh implementations, an apparatus and/or method may further comprise or include any one or more of the following:

In an implementation, the flow cell assembly is coupled to the cartridge assembly by a coupling.

In another implementation, the coupling includes a snap fit connection.

In another implementation, the cartridge assembly includes a pair of locating posts and the body of the flow cell assembly includes a pair of locating holes that register with the corresponding locating posts.

In another implementation, the cartridge assembly includes a pump coupled to at least one of the outlet gasket of the flow cell assembly or between the well and the flow cell assembly.

In another implementation, the pump includes a syringe pump.

In another implementation, the apparatus also includes dried reagent contained within the well and the syringe pump is used to flow rehydrated dried reagent from the well to the flow cell.

In another implementation, the body includes a first groove and a second groove. The first laminate covering the first groove to form the first fluidic channel and the second laminate covering the second groove to form the second fluidic channel.

In another implementation, the flow cell assembly includes a second flow cell supported by the body.

In another implementation, the flow cell and the second flow cell are fluidly coupled in series.

In another implementation, the flow cell outlet of the flow cell is fluidly coupled to the flow cell outlet gasket via the second flow cell.

In another implementation, the body of the flow cell assembly and the second flow cell are coupled by a coupling.

In another implementation, the body of the flow cell assembly and the flow cell are coupled by a coupling.

In another implementation, the coupling includes a first snap-fit cantilever and a second snap-fit cantilever. The first snap-fit cantilever positioned on a first side of the flow cell and the second snap-fit cantilever positioned on a second side of the flow cell.

In another implementation, the first snap-fit cantilever biases the flow cell in the x-direction and the second snap-fit cantilever biases the flow cell in the y-direction.

In another implementation, the coupling includes a pair of hold downs including a lip to be positioned overtop of the flow cell.

In another implementation, both of the hold downs are positioned on a side of the flow cell.

In another implementation, the coupling includes a x-datum projection and a y-datum projection against which the flow cell engages.

In another implementation, the apparatus includes a second x-datum projection.

In another implementation, the apparatus includes a second flow cell assembly including a second flow cell being different than the flow cell. The second flow cell assembly couplable to the cartridge assembly in place of the flow cell assembly.

In another implementation, the apparatus includes a third flow cell assembly including a third flow cell and a fourth flow cell. The third flow cell assembly couplable to the cartridge assembly in place of the flow cell assembly and in place of the second flow cell assembly.

In another implementation, the flow cell assembly includes a second flow cell supported by the body.

In another implementation, the flow cell and the second flow cell are fluidly coupled in series.

In another implementation, the body carries a second flow cell inlet gasket and a second flow cell outlet gasket. The second flow cell includes a channel including a flow cell inlet and a flow cell outlet. The flow cell inlet of the second flow cell is fluidly coupled to the second flow cell inlet gasket and the flow cell outlet of the second flow cell is fluidly coupled to the second flow cell outlet gasket.

In another implementation, the second laminate forms the second fluidic channel between the second flow cell outlet gasket and the outlet gasket.

In another implementation, the apparatus includes a third fluidic channel between the flow cell outlet gasket and the second flow cell inlet gasket.

In another implementation, the second laminate forms the third fluidic channel.

In another implementation, the body includes a first groove, a second groove, and a third groove. The first laminate covering the first groove to form the first fluidic channel and the third groove to form the third fluidic channel and the second laminate covering the second groove to form the second fluidic channel.

In another implementation, the body includes locating posts and the second laminate includes locating holes that receive the corresponding locating posts.

In another implementation, the body defines a window to allow visual access of the flow cell.

In another implementation, the body includes locating posts and the first laminate includes locating holes that receive the corresponding locating posts.

In another implementation, the body includes a plurality of first pads and a plurality of second pads. The first pads opposing the second pads.

In another implementation, the flow cell rests on the first pads.

In another implementation, the body defines a window to allow visual access of the flow cell. The window includes corners. The first pads and the second pads are located adjacent the corresponding corners.

In another implementation, the body of the flow cell assembly and the flow cell are coupled by a coupling.

In another implementation, the coupling includes tape.

In another implementation, the flow cell assembly includes a second flow cell supported by the body.

In another implementation, the flow cell and the second flow cell are fluidly coupled in series.

In another implementation, the flow cell and the second flow cell have longitudinal axes that are substantially parallel to one another.

In another implementation, the flow cell and the second flow cell have longitudinal axes that are substantially coaxial.

In another implementation, the flow cell and the second flow cell are fluidly coupled in parallel.

In another implementation, the flow cell and the second flow cell have longitudinal axes that are substantially parallel to one another.

In another implementation, the flow cell and the second flow cell have longitudinal axes that are substantially coaxial.

In another implementation, the method includes coupling a flow cell inlet gasket, a flow cell outlet gasket, and an outlet gasket with a body of a second flow cell assembly, the body of the second flow cell assembly including a fluidic aperture; coupling a first laminate to the body of the second flow cell assembly to form a first fluidic channel between the flow cell outlet gasket and the fluidic aperture of the second flow cell assembly; coupling a second laminate to the body of the second flow cell assembly to form a second fluidic channel between the fluidic aperture and the outlet gasket of the second flow cell assembly; and coupling a second flow cell and the body of the second flow cell assembly.

In another implementation, the flow cell and the second flow cell are different.

In another implementation, the method includes mechanically and fluidly coupling the flow cell assembly or the second flow cell assembly and a cartridge assembly.

In another implementation, the flow cell assembly and the second flow cell assembly are interchangeably mechanically and fluidly couplable with the cartridge assembly.

In another implementation, the cartridge assembly includes a fluidic interface, a well, a channel fluidly coupled between the fluidic interface and the well, and an outlet port fluidly coupled to the well and to one of the flow cell assembly or the second flow cell assembly.

In another implementation, flowing the liquid under positive pressure includes using a gas source.

In another implementation, the cartridge assembly includes the pump.

In another implementation, the pump includes a syringe pump.

In another implementation, the pump is positioned upstream of the flow cell.

In another implementation, the pump is positioned downstream of the flow cell.

In another implementation, flowing the liquid under positive pressure into the well includes pressurizing a storage chamber of a reagent reservoir including the liquid and flowing the liquid from the storage chamber to the cartridge assembly.

In another implementation, the flow cell assembly includes the body carrying the flow cell inlet gasket, a flow cell outlet gasket, and an outlet gasket. The body includes a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and the flow cell supported by the body and includes a channel including a flow cell inlet and a flow cell outlet, the flow cell inlet fluidly coupled to the flow cell inlet gasket and the flow cell outlet fluidly coupled to the flow cell outlet gasket.

In another implementation, flowing a reagent through the flow cell assembly.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a isometric view of an example implementation of a cartridge assembly and a flow cell assembly that can be used to implement the cartridge assembly and the flow cell assembly of FIG. 1.

FIG. 3 is an isometric partially expanded view of the flow cell assembly of FIG. 2.

FIG. 4 is a top isometric view of the body of the flow cell assembly of FIG. 2.

FIG. 5 is a bottom isometric view of the body of the flow cell assembly of FIG. 2.

FIG. 6 is a bottom isometric view of the body of the flow cell assembly of FIG. 2.

FIG. 7 is a detailed top isometric view of the flow cell assembly of FIG. 2.

FIG. 8 is an expanded isometric view of an example implementation of a flow cell assembly having a body that can be used to implement the flow cell assembly of FIG. 1.

FIG. 9 is a top isometric view of the flow cell assembly of FIG. 8 with the flow cell and the second laminate not shown.

FIG. 10 is a bottom isometric view of the flow cell assembly of FIG. 8.

FIG. 11 is an expanded isometric view of an example implementation of a flow cell assembly having a body that can be used to implement the flow cell assembly of FIG. 1.

FIG. 12 is a top isometric view of the flow cell assembly of FIG. 11 with the second flow cell and the second laminate not shown.

FIG. 13 is a bottom isometric view of the flow cell assembly of FIG. 11.

FIG. 14 is an expanded isometric view of an example implementation of a flow cell assembly that can be used to implement the flow cell assembly of FIG. 1.

FIG. 15 is an expanded isometric view of an example implementation of the cell assembly of FIG. 14.

FIG. 16 is a plan view of an example implementation of a flow cell assembly that can be used to implement the flow cell assembly of FIG. 1.

FIG. 17 is a plan view of an example implementation of a flow cell assembly that can be used to implement the flow cell assembly of FIG. 1.

FIG. 18 is a plan view of an example implementation of a flow cell assembly that can be used to implement the flow cell assembly of FIG. 1.

FIG. 19 is a plan view of an example implementation of a flow cell assembly that can be used to implement the flow cell assembly of FIG. 1.

FIG. 20 is a plan view of an example implementation of a flow cell assembly that can be used to implement the flow cell assembly of FIG. 1.

FIG. 21 illustrates a flow chart for a method of manufacturing the flow cell assemblies of FIGS. 1-20 and/or the cartridge assemblies of FIGS. 1-2 or any of the other implementations disclosed herein.

FIG. 22 illustrates a flow chart for a method of using the flow cell assemblies of FIGS. 1-20 and/or the cartridge assemblies of FIGS. 1-2 or any of the other implementations disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The implementations disclosed relate to flow cell assemblies and related cartridge assemblies that allow the flow cell assemblies to be interchangably used with the same cartridge assembly. The same cartridge assembly and/or the same system/instrument may be used with these different flow cell assemblies, which allows customers greater flexibility while also reducing part counts and related costs. Some of the flow cell assemblies may include a smaller flow cell, some of the flow cell may include a larger flow cell, and/or some of the flow cells may include two or more flow cells. The flow cell assembly may be integrated into the cartridge assembly once attached.

The flow cell assemblies may include a body that can be mechanically coupled to the cartridge assembly by a snap-fit connection. The flow cell assemblies may also include inlet and outlet gaskets in locations that allow the gaskets to fluidly couple with the cartridge assembly regardless of flow cell assembly attached.

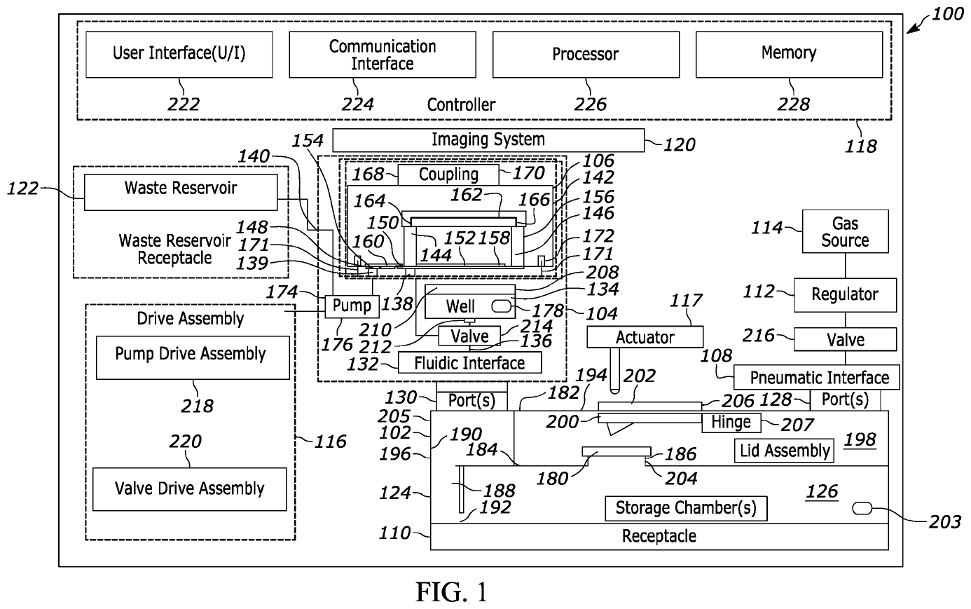

FIG. 1 illustrates a schematic diagram of an implementation of a system 100 in accordance with the teachings of this disclosure. The system 100 can be used to perform an analysis on one or more samples of interest. The sample may include one or more DNA clusters that are linearized to form a single stranded DNA (sstDNA). In the implementation shown, the system 100 receives a liquid reservoir 102, a cartridge assembly 104, and a flow cell assembly 106 and includes, in part, a pneumatic interface 108, a receptacle 110, a regulator 112, a gas source 114, a drive assembly 116, an actuator 117, a controller 118, an imaging system 120, and a waste reservoir 122. The liquid reservoir 102 and/or the cartridge assembly 104 may be referred to as a consumable, a reagent reservoir, or a reagent assembly. The waste reservoir 122 may alternatively be carried by the liquid reservoir 102 as an example. The controller 118 is electrically and/or communicatively coupled to the regulator 112, the drive assembly 116, the actuator 117, and the imaging system 120 and causes the regulator 112, the drive assembly 116, the actuator 117, and/or the imaging system 120 to perform various functions as disclosed herein.

The liquid reservoir 102 is receivable within the receptacle 110 and has a body 124 including a storage chamber 126, a pneumatic port 128 fluidly couplable to the storage chamber 126, and a fluidic port 130 fluidly coupled to the storage chamber 126. The cartridge assembly 104 has a fluidic interface 132 couplable to the fluidic port 130, a well 134, and a channel 136 fluidly coupled between the fluidic interface 132 and the well 134. The cartridge assembly 104 also includes an outlet port 138 fluidly coupled to the well 134, an inlet port 139, and an outlet port 140 fluidly coupled to the waste reservoir 122. The outlet port 140 may alternatively be fluidly coupled to the liquid reservoir 102 when the waste reservoir 122 is omitted and/or included with the liquid reservoir 102.

The flow cell assembly 106 includes a body 142 carrying a flow cell inlet gasket 144, a flow cell outlet gasket 146, and an outlet gasket 148. The body 142 also includes a fluidic aperture 150. The flow cell assembly 106 is shown including a first laminate 152, a second laminate 154, and a flow cell 156 supported by the body 142. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. The flow cell inlet gasket 144 may be referred to as a flow cell assembly inlet gasket and the outlet gasket 148 may be referred to as a flow cell assembly outlet gasket. The flow cell inlet gasket 144 may thus be both the inlet gasket for the flow cell assembly 106 and the inlet gasket for the flow cell 156.

The flow cell 156 may support the sample of interest. The cartridge assembly 104 may include a flow cell receptacle that receives the flow cell 156. The first laminate 152 is coupled to the body 142 and forms a first fluidic channel 158 between the flow cell outlet gasket 146 and the fluidic aperture 150 and the second laminate 154 is coupled to the body 142 and forms a second fluidic channel 160 between the fluidic aperture 150 and the outlet gasket 148. The first laminate 152 and/or the second laminate 154 can be coupled to the body 142 by laser welding.

The flow cell 156 is supported by the body 142 and includes a channel 162 having a flow cell inlet 164 and a flow cell outlet 166. The flow cell inlet 164 is fluidly coupled to the flow cell inlet gasket 144 and the flow cell outlet 166 is fluidly coupled to the flow cell outlet gasket 146. The outlet port 138 of the cartridge assembly 104 is fluidly coupled to the flow cell inlet gasket 144 once the flow cell assembly 106 is coupled to the cartridge assembly 104, for example.

The flow cell assembly 106 is coupled to the cartridge assembly 104 by a coupling 168 in the implementation shown. The coupling 168 may be a snap-fit connection 170. The coupling 168 may be implemented in a different way, however. The cartridge assembly 104 also includes a pair of locating posts 171 and the body 142 of the flow cell assembly 106 has a pair of locating holes 172 that register with the corresponding locating posts 171. One of the locating holes 172 may be circular and the other of the locating holes 172 may be oblong as an example.

The cartridge assembly includes a pump 174 in the implementation shown coupled to the outlet gasket 148 of the flow cell assembly 106. The pump 174 may alternatively be positioned between the well 134 and the flow cell assembly 106 or in another location. The pump 174 may be a syringe pump 176 and dried reagent 178 contained within the well 134 and the syringe pump 176 is used to flow rehydrated dried reagent 178 from the well 134 to the flow cell 156. The dried reagent and/or dry reagent may be lyophilized reagent(s), for example. The pump 174 may alternatively be part of the system 100. The pump 174 may alternatively be omitted. The pump 174 may be implemented by the syringe pump 176, a peristaltic pump, a diaphragm pump, etc. While the pump 174 may be positioned downstream of the flow cell 156 as shown, the pump 174 may be positioned upstream of the flow cell 156 or omitted entirely.

The liquid reservoir 102 is receivable within the receptacle 110 and includes the body 124, a cover 180, and a lid assembly 182. The body 124 has a top surface 184 and the storage chamber 126 having an opening 186 at the top surface 184. The body 124 also has a sipper chamber 188 having an opening 190 at the top surface 184 and a fluidic sinus 192 fluidly coupling the storage chamber 126 and the sipper chamber 188.

The cover 180 covers the opening 186 of the storage chamber 126 and the lid assembly 182 is coupled to the top surface 184. The lid assembly 182 may be laser welded to the top surface 184 of the liquid reservoir 102. The lid assembly 182 may be coupled to the top surface 184 in different ways, however, including adhesive or using another coupling for example. The cover 180 may be implemented by plastic, foil, rubber, a seal, and/or a plug. The

The lid assembly 182 has a first portion 194 covering the opening 186 of the storage chamber 126 and a second portion 196 covering the opening 190 of the sipper chamber 188. The top surface 184 of the body 124 and the second portion 196 define a plenum 198.

The first portion 194 of the lid assembly 182 has the pneumatic port 128, a cantilever 200, and a compliant barrier 202. The cantilever 200 and the compliant barrier 202 may be formed using a two-shot molding process in some implementations. The compliant barrier 202 may comprise or be formed of a thermoplastic elastomer (TPE) as an example. The compliant barrier 202 may have a thickness of about 0.9 millimeters (mm). The compliant barrier 202 may be made of another material and/or have a different thickness, however.

The pneumatic port 128 is fluidly coupled to the plenum 198. The cantilever 200 may be referred to as a piercer. The cantilever 200 has a distal end and the compliant barrier 202 covers the cantilever 200 and defines a portion of the plenum 198. The fluidic port 130 is fluidly coupled to the opening 190 of the sipper chamber 188.

The actuator 117 is movable to engage the compliant barrier 202 in operation and move the distal end of the cantilever 200 to pierce the cover 180 and allow the storage chamber 126 to be fluidly coupled to the plenum 198. The system 100 can thus indirectly actuate the cantilever 200 without the system 100 compromising and/or accessing an interior of the liquid reservoir 102. The engagement between the actuator 117 and the compliant barrier 202 does not vent the plenum 198 to atmosphere as a result.

Liquid 203 is contained within the storage chamber 126 and dried reagent 178 is contained within the well 134. The liquid 203 may be a rehydrating liquid and/or a wash buffer. The liquid 203 may be a different type of liquid, however. The dried reagent 178 may be lyophilized reagent as an example. The liquid reservoir 102 may include any number of storage chambers 126 including one storage chamber as shown and the cartridge assembly 104 may include any number wells 134 including one well as shown. The number of storage chambers 126 that the liquid reservoir 102 has may correspond to the number of wells 134 that the cartridge assembly 104 has in some examples.

The liquid reservoir 102 and/or the cartridge assembly 104 includes a thermoplastic. The liquid reservoir 102 and/or the cartridge assembly 104 may additionally or alternatively include polypropylene and/or cyclic olefin copolymer (COC) with an over molded Santoprene thermoplastic elastomer (TPE) or another thermoplastic elastomer. Other materials may prove suitable for the liquid reservoir 102 and/or the cartridge assembly 104.

The cover 180 that covers the opening 186 may include foil and the compliant barrier 202 may include an elastomer and/or a conformable foil. The foil may be a foil with a lacquer backing for bonding to the thermoplastic of the body 124 in some implementations. The lacquer is a coating applied to the cover 180 that promotes the bonding to the body 124 when heat staked, for example. The cover 180 and/or the compliant barrier 202 may additionally or alternatively include plastic. The body 124 of the liquid reservoir 102 includes a port 204 that defines the opening 186 in the implementation shown. The cover 180 is coupled to the port 204. The cover 180 may alternatively be coupled within the port 204 to seal the port 204, for example. The port 204 may alternatively be omitted.

The cover 180 is pierced by the cantilever 200 in operation prior to the storage chamber 126 being pressurized by the gas source 114, for example. The cantilever 200 piercing the cover 180 may allow the pneumatic interface 108 to pressurize the storage chamber 126. The actuator 117 may engage and move the compliant barrier 202 and in turn move the cantilever 200 to pierce the cover 180. The cover 180 may be pierced in different ways, however.

The lid assembly 182 in the implementation shown includes a body 205 having the cantilever 200 and the compliant barrier 202 is coupled to the body 205 and covers the cantilever 200. The body 205 has an aperture 206 and the compliant barrier 202 covers the aperture 206. The aperture 206 may alternatively be referred to as an opening or a window. The actuator 117 can move the cantilever 200 by moving the compliant barrier 202 relative to and/or through the aperture 206. The aperture 206 being larger may reduce an amount of force used to actuate the cantilever 200. The cantilever 200 may be adapted to pierce the cover 180 and allow the cover 180 to be pneumatically coupled to the plenum 198. The body 205 has a living hinge 207 coupled to the cantilever 200. The living hinge 207 allows the cantilever 200 to move relative to the remainder of the body 205 and for the cantilever 200 to pierce the cover 180. The cantilever 200 may be movably coupled to the body 205 in different ways, however.

The cartridge assembly 104 includes a cover 208 shown covering the well 134. The cover 208 may include and/or form a vent 210 that allows air flow out of the well 134. The vent 210 is sized to substantially retain the dried reagent 178 within the well 134. The use of the dried reagent 178 in the disclosed implementations may simplify storage requirements, reduce shipping costs, and increase the speed of workflows by, for example, avoiding thaw time before the reagent may be used.

The well 134 includes a port 212 and the liquid 203 can flow into the well 134 via the port 212 in practice to rehydrate the dried reagent 178. The vent 210 may vent gas from the well 134 as the liquid 203 flows into the well 134 and the cover 208 prevents or inhibits the dried reagent 178 and/or the liquid 203 from escaping from the well 134. Put another way, the vent 210 retains the dried reagent 178 and/or the liquid 203 within the wells 160 and prevents or inhibits the dried reagent 178 and/or the liquid 203 from migrating out of the wells 160. The vent 210 and the cover 208 prevents or inhibits cross-contamination between reagents when the liquid reservoir 102 includes more than one well 134. The liquid 203 and the dried reagent 178 can be flowed into and out of the well 134 to mix the liquid 203 from the liquid reservoir 102 and the dried reagent 178. The system 100 and/or the liquid reservoir 102 may include a mixing chamber that is used to mix the liquid 203 and the dried reagent 178 in some implementations.

The gas source 114 may be used to pressurize the liquid reservoir 102 to flow the liquid 203 into the well 134 and/or the pump 174 may draw the liquid 203 from the liquid reservoir 102 and flow the liquid 203 into the well 134 to rehydrate the dried reagent 178. The pump 174 may be used to draw the rehydrated reagent from the well 134 and flow the rehydrated reagents to the flow cell 156 in some implementations. The gas source 114 may be provided by the system 100 and/or the gas source 114 may be carried by the liquid reservoir 102. The gas source 114 may alternatively be omitted.

The cartridge assembly 104 is shown including a valve(s) 214 that may be actuatable to control the flow of the liquid 203 from the liquid reservoir 102 to the well 134 and/or the flow cell 156. The valve 214 may be implemented by a three-way valve, a valve manifold, a rotary valve, a selector valve, a pinch valve, a flat valve, a solenoid valve, a check valve, a piezo valve, etc.

The liquid reservoir 102 and/or the system 100 includes a valve 216 that may be selectively actuatable to control the flow of fluid (gas) to the liquid reservoir 102. The valve 216 may be implemented by a valve manifold, a rotary valve, a selector valve, a pinch valve, a flat valve, a solenoid valve, a check valve, a piezo valve, etc. The regulator 112 can be positioned between the gas source 114 and the valve 216 and regulates a pressure of the gas provided to the valve 216. The regulator 112 may be a valve that controls the flow of the gas from the gas source 114.

The gas source 114 and/or the pump 174 may flow the liquid 203 to rehydrate dried reagents 178 and to flow one or more liquid reagents (e.g., A, T, G, C nucleotides) through the liquid reservoir 102 that interact with the sample. The gas source 114 may flow the liquid 203 to rehydrate the dry reagents 178 on the cartridge assembly 104 and the pump 174 on the cartridge assembly 104 may flow the rehydrated reagent (e.g., A, T, G, C nucleotides) to the flow cell 156 that interact with the sample as an example. The reagent with a reversible terminator in an implementation allows a single nucleotide to be incorporated by the sstDNA per cycle. One or more of the nucleotides has a unique fluorescent label in such implementations that emits a color when excited. The color (or absence thereof) is used to detect the corresponding nucleotide. The imaging system 120 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 120 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 116 interfaces with the liquid reservoir 102 to flow another reaction component (e.g., a reagent) through the flow cell 156 that is thereafter received by the waste reservoir 122 and/or otherwise exhausted by the cartridge assembly 104. The reaction component performs a flushing operation that chemically cleaves the fluorescent label and the reversible terminator from the sstDNA. The sstDNA is then ready for another cycle.

Referring now to the drive assembly 116, in the implementation shown, the drive assembly 116 includes a pump drive assembly 218 and a valve drive assembly 220. The pump drive assembly 218 interfaces with the pump 174 to pump fluid through the liquid reservoir 102 and/or the flow cell 156 and the valve drive assembly 220 interfaces with the valves 214 and/or 216 to control the position of the valves 214 and/or 216.

Referring to the controller 118, in the implementation shown, the controller 118 includes a user interface 222, a communication interface 224, one or more processors 226, and a memory 228 storing instructions executable by the one or more processors 226 to perform various functions including the disclosed implementations. The user interface 222, the communication interface 224, and the memory 228 are electrically and/or communicatively coupled to the one or more processors 226.

In an implementation, the user interface 222 receives input from a user and provides information to the user associated with the operation of the system 100 and/or an analysis taking place. The user interface 222 may include a touch screen, a display, a keyboard, a speaker(s), a mouse, a track ball, and/or a voice recognition system. The touch screen and/or the display may display a graphical user interface (GUI).

In an implementation, the communication interface 224 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 226 and/or the system 100 may include one or more of a processor-based system(s) or a microprocessor-based system(s). In some implementations, the one or more processors 226 and/or the system 100 includes a reduced-instruction set computer(s) (RISC), an application specific integrated circuit(s) (ASICs), a field programable gate array(s) (FPGAs), a field programable logic device(s) (FPLD(s)), a logic circuit(s), and/or another logic-based device executing various functions including the ones described herein.

The memory 228 can include one or more of a hard disk drive, a flash memory, a read-only memory (ROM), erasable programable read-only memory (EPROM), electrically erasable programable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

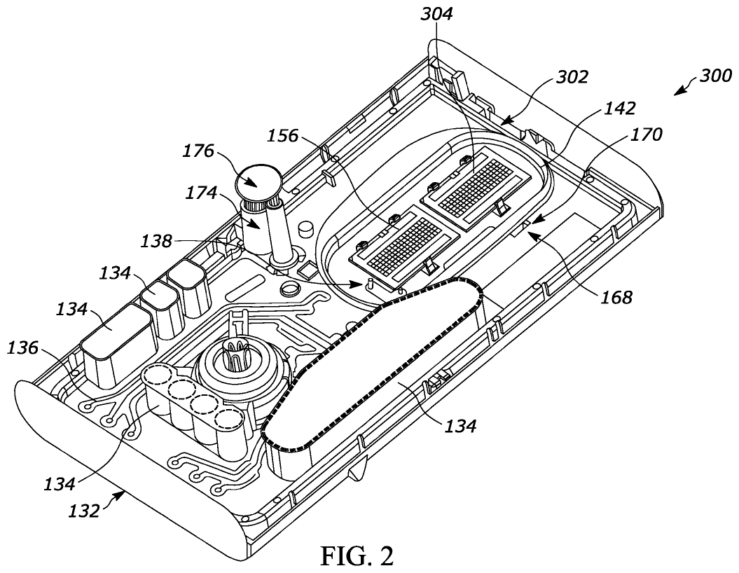

FIG. 2 is an isometric view of an example implementation of a cartridge assembly 300 and a flow cell assembly 302 that can be used to implement the cartridge assembly 104 and the flow cell assembly 106 of FIG. 1. The cartridge assembly 300 includes the fluidic interface 132 and a plurality of the wells 134. The flow cell assembly 302 is coupled to the cartridge assembly 300 by the snap-fit connection 170. The flow cell assembly 302 also includes a second flow cell 304 supported or otherwise carried by the body 142. The first flow cell 156 and the second flow cell 304 may be substantially identical structures in some implementations. The first flow cell 156 and the second flow cell 304 may be different structures in other implementations. The first flow cell 156 and the second flow cell 304 are shown being in an end-to-end vertical configuration relative to the cartridge assembly 300. The first flow cell 156 and the second flow cell 304 may be considered to be in an end-to-end horizontal configuration relative to the cartridge assembly 300 if the first flow cell 156 and the second flow cell 304 are oriented about 90° to the position shown. The second flow cell 304 has a channel 162 including a flow cell inlet 164 and a flow cell outlet 166. The flow cell 156 may be referred to as a third flow cell and the second flow cell 304 may be referred to as a fourth flow cell. The flow cell 156 and the second flow cell 304 are fluidly coupled in series in the implementation shown. The flow cell 156 and the second flow cell 304 may be coupled in different ways, however. The flow cell 156 and the second flow cell 304 may be coupled in parallel and/or oriented differently as examples.

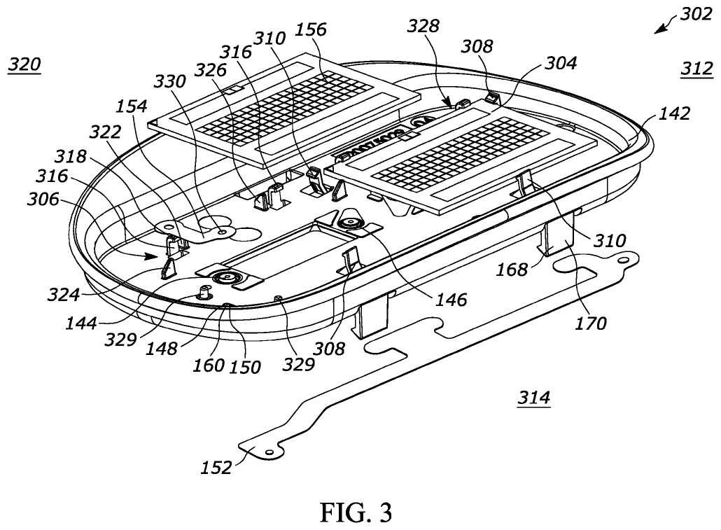

FIG. 3 is an isometric partially expanded view of the flow cell assembly 302 of FIG. 2. The flow cell assembly 302 shows the first laminate 152 and the second laminate 154 that are used to form the first fluidic channel 158 and the second fluidic channel 160. The body 142 of the flow cell assembly 106 and the flow cell 156 are coupled by a coupling 306. The coupling 306 includes a first snap-fit cantilever 308 and a second snap-fit cantilever 310. The first snap-fit cantilever 308 is positioned on a first side 312 of the flow cell 156 and the second snap-fit cantilever 310 is positioned on a second side 314 of the flow cell 156. The first snap-fit cantilever 308 biases the flow cell 156 in the x-direction and the second snap-fit cantilever 310 biases the flow cell 156 in the y-direction in the implementation shown. The coupling 306 also includes a pair of hold downs 316 having a lip 318 that is arranged to be positioned overtop of the flow cell 156. Both of the hold downs 316 are positioned on a side 320 of the flow cell 156. The hold downs 316 may be in a different position. The coupling 306 has a x-datum projection 322 and a y-datum projection 324 in the implementation shown against which the flow cell 156 engages. The coupling 306 also includes has a second x-datum projection 326. The first snap-fit cantilever 308 biases the flow cell 156 into engagement with the x-datum projections 322, 326 and the second snap-fit connection 310 biases the flow cell 156 into engagement with the y-datum projection 324. The second flow cell 304 and the body 142 of the flow cell assembly 106 are coupled by a coupling 328 that is similar or the same as the coupling 306.

The body 142 has locating posts 329 in the implementation shown and the second laminate 154 has locating holes 330 that receive the corresponding locating posts 329. The locating holes 330 receiving the locating posts 329 aligns the second laminate 154 relative to the body 142 to form the second fluidic channel 160.

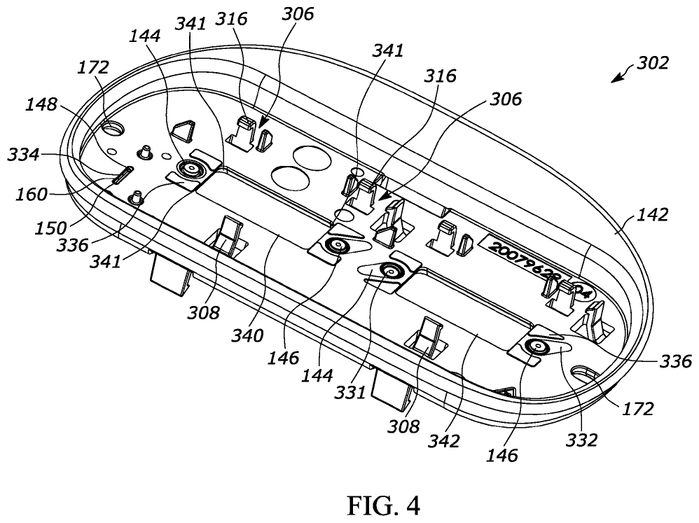

FIG. 4 is a top isometric view of the body 142 of the flow cell assembly 302 of FIG. 2. The flow cell assembly 302 includes the flow cell inlet gasket 144 and the flow cell outlet gasket 146 for the flow cell 156 and also includes a second flow cell inlet gasket 331 and a second flow cell outlet gasket 332 for the second flow cell 304. The second flow cell outlet gasket 332 may be referred to as a flow cell outlet gasket and the second flow cell inlet gasket 331 may be referred to as a flow cell inlet gasket. The flow cell inlet 164 of the second flow cell 304 is fluidly coupled to the second flow cell inlet gasket 331 and the flow cell outlet 166 of the second flow cell 304 is fluidly coupled to the second flow cell outlet gasket 332 when the second flow cell 304 is supported by the flow cell assembly 302. The arrangement of the gaskets 144, 146, 331, 332 allows the flow cell 156 and the second flow cell 304 to be coupled in series. The flow cell outlet 166 of the flow cell 156 is fluidly coupled to the flow cell outlet gasket 332 via the second flow cell 304 in the implementation shown.

The body 142 also includes a groove 334 in the implementation shown. The groove 334 may be referred to as the second groove. The groove 334 may be covered by the second laminate 154 to form the second fluidic channel 160.

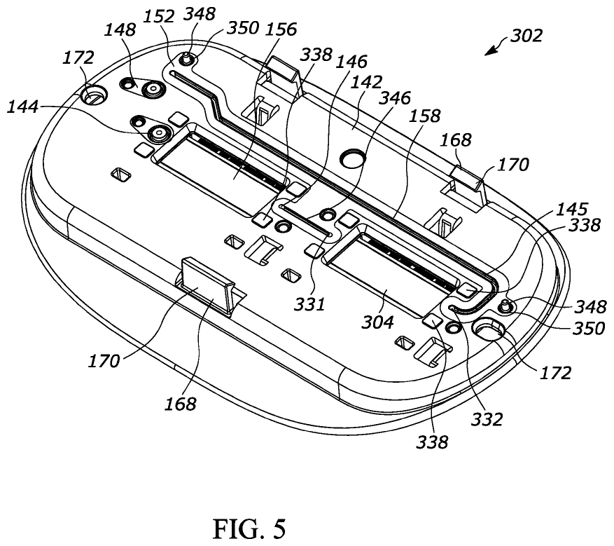

The body 142 includes a plurality of first pads 336 and a plurality of second pads 338 (FIG. 5). The first pads 336 oppose the second pads 338. The flow cell 156 and/or 304 rests on the corresponding first pads 336 when the flow cells 156, 304 are supported by the flow cell assembly 302. The pads 336, 338 may be positioned to allow a force to be applied to the flow cell 156 and/or 304 and for that force to be transferred through the flow cell 146 and/or 304 to the pads 336, 338 and into the cartridge assembly 300 and/or the instrument as an example.

The body 142 includes a window 340 that allows visual access of the flow cell 156. The window 340 has corners 341 and the first pads 336 and the second pads 338 are located adjacent the corresponding corners 341. The body 42 also includes a second window 342 that allows visual access of the second flow cell 304. The second window 342 may be omitted in implementations when the flow cell assembly 302 does not include the second flow cell 304.

FIG. 5 is a bottom isometric view of the body 142 of the flow cell assembly 302 of FIG. 2. The body 142 includes a groove 145 and the first laminate 152 covers the groove 145 to form the first fluidic channel 158. The groove 145 may be referred to as the first groove. The flow cell assembly 302 also includes a third fluidic channel 346 between the flow cell outlet gasket 146 and the second flow cell inlet gasket 331. The first laminate 152 forms the third fluidic channel 346 in the implementation shown. The flow cell assembly 302 may alternatively include another laminate coupled to the body 142 of the flow cell assembly 302 to form the third fluidic channel 346.

The body 142 has locating posts 348 in the implementation shown and the first laminate 152 has locating holes 350 that receive the corresponding locating posts 348. The locating holes 348 receiving the locating posts 348 aligns the first laminate 152 relative to the body 142 to form the first fluidic channel 158 and the third fluidic channel 346.

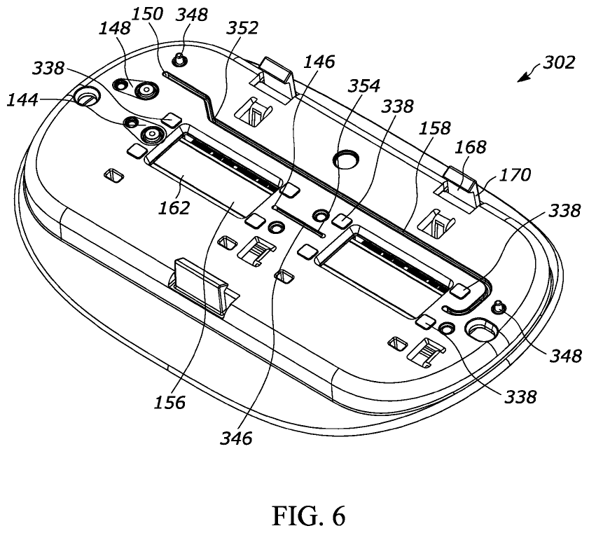

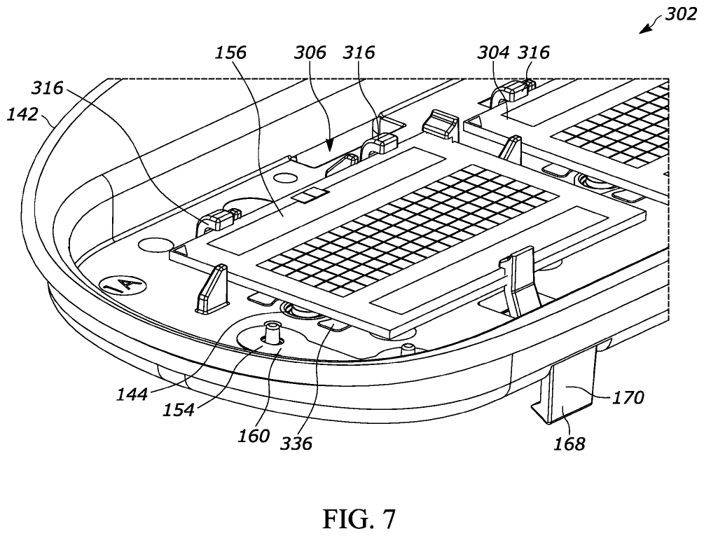

FIG. 6 is a bottom isometric view of the body 142 of the flow cell assembly 302 of FIG. 2. The body 142 has a first groove 352, the second groove 334 (FIG. 4), and a third groove 354. The first laminate 152 covers the first groove 352 to form the first fluidic channel and the third groove 354 to form the third fluidic channel 346 as shown in FIG. 5 and the second laminate 154 covers the second groove 334 to form the second fluidic channel 160 as shown in FIG. 7.

FIG. 7 is a detailed top isometric view of the flow cell assembly 302 of FIG. 2. The second laminate 154 is coupled to the body 142 to form the second fluidic channel 160 and the coupling 306 is shown securing the flow cell 156 to the body 142 of the flow cell assembly 302.

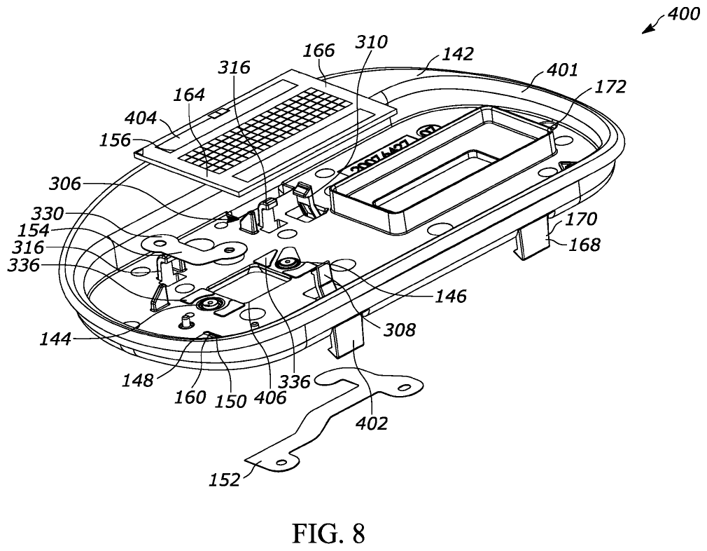

FIG. 8 is an expanded isometric view of an example implementation of another flow cell assembly 400 having a body 401 that can be used to implement the flow cell assembly 106 of FIG. 1. The flow cell assembly 400 may be referred to as a second flow cell assembly 400. The flow cell assembly 400 is similar to the flow cell assembly 302 in that both the flow cell assembly 302 and the flow cell assembly 400 mechanically and fluidly couple with the cartridge assembly 300 and/or the system 100 interchangably. The flow cell assembly 302 and the flow cell assembly 400 have cantilevers 402 of the snap-fit connection 170 in the same or substantially the same location to allow the flow cell assembly 302 and the flow cell assembly 400 to mechanically couple with the cartridge assembly 300 in the same or similar way. The flow cell assembly 302 and the flow cell assembly 400 may also have the flow cell inlet gasket 144 and the outlet gasket 148 in the same or substantially the same location to allow the flow cell assembly 302 and the flow cell assembly 400 to fluidly couple with the cartridge assembly 300 in the same or in a similar way.

The flow cell assembly 400 includes a flow cell 404 but does not include an additional flow cell in the implementation shown. The flow cell 404 may be referred to as a second flow cell. The flow cell 404 may be different from the flow cell 156 shown in FIG. 2. The flow cell 404 may have different flow cell channel volumes from the flow cell channel volumes of the flow cell 156 shown in FIG. 2, for example. The flow cell outlet gasket 146 is shown positioned closer to the flow cell inlet gasket 144 to allow the flow cell inlet 164 and the flow cell outlet 166 of the flow cell 404 to fluidly couple with the gaskets 144, 146. The flow cell outlet gasket 146 may be positioned closer to the flow cell inlet gasket 144 in the flow cell assembly 400 as compared to the relative position of the flow cell outlet gasket 146 and the flow cell inlet gasket 144 in the flow cell assembly 302 of FIG. 2.

The flow cell assembly 400 includes the first laminate 152 and the second laminate 154 similar to the laminates 152, 154 used with the flow cell assembly 302 of FIG. 2. The flow cell assembly 400 does not include an additional flow cell so the laminates 152, 154 used with the flow cell assembly 400 have a different configuration from the laminates 152, 154 used with the flow cell assembly 302 of FIG. 2. The first laminate 152 is to be coupled to the body 401 and forms the first fluidic channel 158 between the flow cell outlet gasket 146 and the fluidic aperture 150 and the second laminate 154 is to be coupled to the body 401 and forms the second fluidic channel 160 between the fluidic aperture 150 and the outlet gasket 148. The body 142 also defines a window 406 to allow visual access of the flow cell 156.

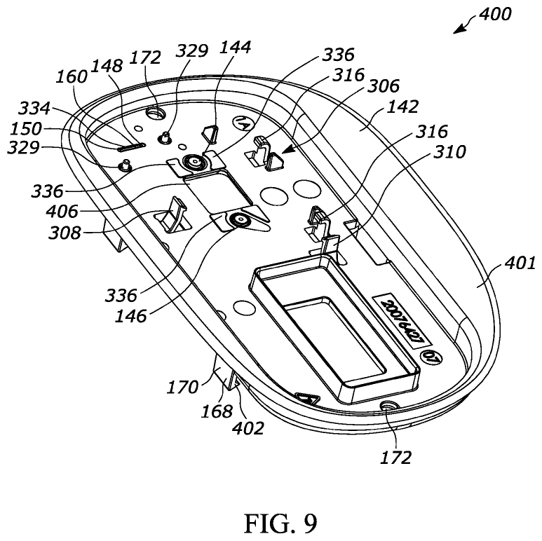

FIG. 9 is a top isometric view of the flow cell assembly 400 of FIG. 8 with the flow cell 404 and the second laminate 154 not shown. The flow cell assembly 400 includes the coupling 306 to secure the flow cell 404 to the body 401 and also includes the groove 334 that may at least partially define the second fluidic line 160.

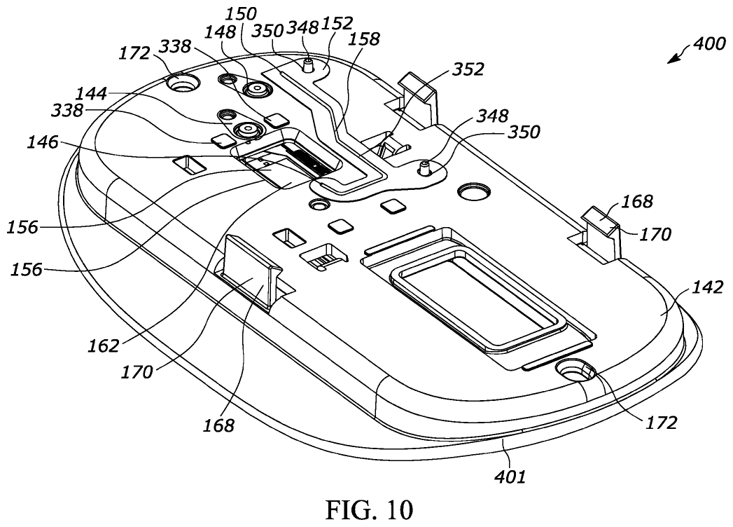

FIG. 10 is a bottom isometric view of the flow cell assembly 400 of FIG. 8. The flow cell assembly 400 includes the first laminate 152 coupled to the body 401 and forming the first fluidic channel 158 between the flow cell outlet gasket 146 and the fluidic aperture 150.

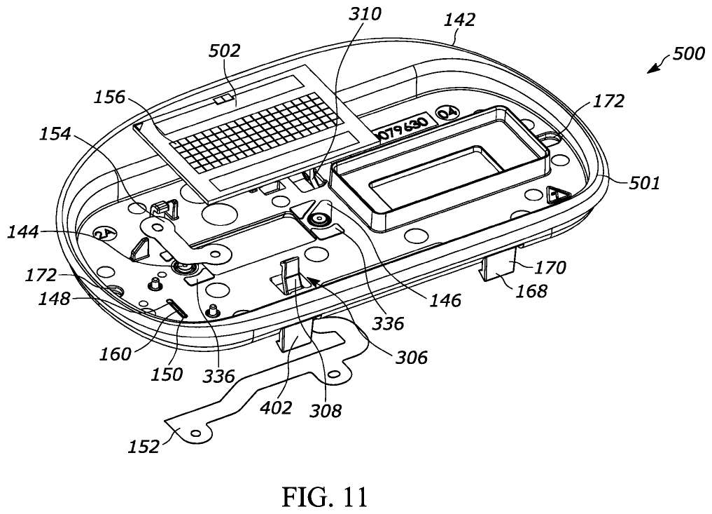

FIG. 11 is an expanded isometric view of an example implementation of a flow cell assembly 500 having a body 501 that can be used to implement the flow cell assembly 106 of FIG. 1. The flow cell assembly 500 is similar to the flow cell assembly 106 and the flow cell assembly 400 in that each of the flow cell assembly 106, the flow cell assembly 400, and the flow cell assembly 500 mechanically and fluidly couple with the cartridge assembly 300 and/or the system 100 interchangeably. The flow cell assembly 106, the flow cell assembly 400, and the flow cell assembly 500 have the cantilevers 402 of the snap-fit connection 170 in the same or substantially the same location to allow the flow cell assembly 106, the flow cell assembly 400, and the flow cell assembly 500 to mechanically couple with the cartridge assembly 300 in the same or similar way. The flow cell assembly 106, the flow cell assembly 400, and the flow cell assembly 500 may also have the flow cell inlet gasket 144 and the outlet gasket 148 in the same or substantially the same location to allow the flow cell assembly 106, the flow cell assembly 400, and the flow cell assembly 500 to fluidly couple with the cartridge assembly 300 in the same or similar way. The system 100 and/or the cartridge assembly 300 may remain the same or substantially the same while allowing the flexibility of using different flow cell assemblies.

The flow cell assembly 500 includes a flow cell 502 but does not include an additional flow cell in the implementation shown. The flow cell 502 may be the same or different from the flow cell 404 shown in FIG. 8 and/or the flow cell 156 shown in FIG. 2, for example. The flow cell 502 may have different flow cell channel volumes from the flow cell channel volumes of the flow cell 156 shown in FIG. 2, for example

The flow cell assembly 500 includes the first laminate 152 and the second laminate 154 similar to the laminates 152, 154 used with the flow cell assembly 400 of FIG. 8. The gaskets 144, 146 of FIG. 11 are further spaced apart because of the size of the flow cell 502 as compared to the spacing of the gaskets 144, 146 of FIG. 8. The first laminate 152 of the flow cell assembly 500 is thus longer to accommodate the position of the gaskets 144, 146 of the flow cell assembly 500 as compared to the length of the first laminate 152 in the flow cell assembly 400.

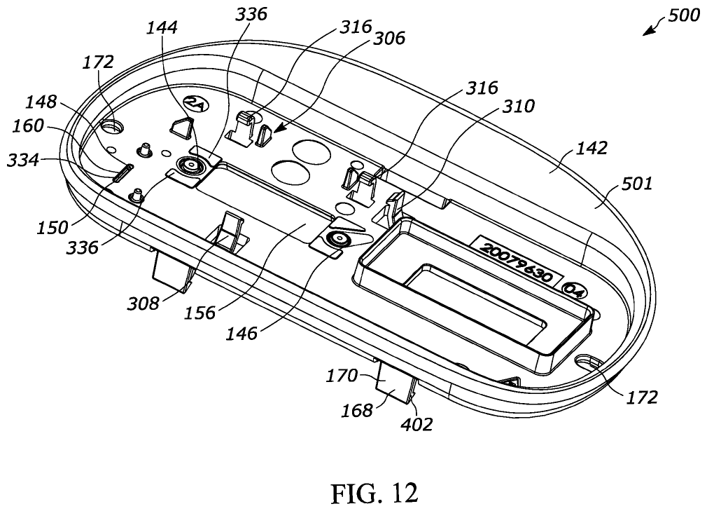

FIG. 12 is a top isometric view of the flow cell assembly 500 of FIG. 11 with the second flow cell 404 and the second laminate 154 not shown. The flow cell assembly 500 includes the coupling 306 to secure the second flow cell 404 to the body 401 and also includes the groove 334 that may at least partially define the second fluidic line 160. The body 501 also includes first pads 336 on which the flow cell 502 is to be positioned.

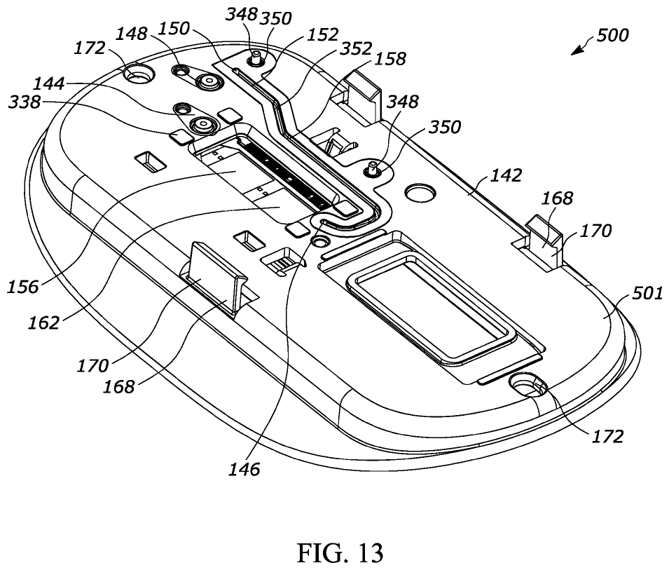

FIG. 13 is a bottom isometric view of the flow cell assembly 500 of FIG. 11. The flow cell assembly 500 includes the first laminate 152 coupled to the body 401 and forming the first fluidic channel 158 between the flow cell outlet gasket 146 and the fluidic aperture 150. The body also includes the second pads 338.

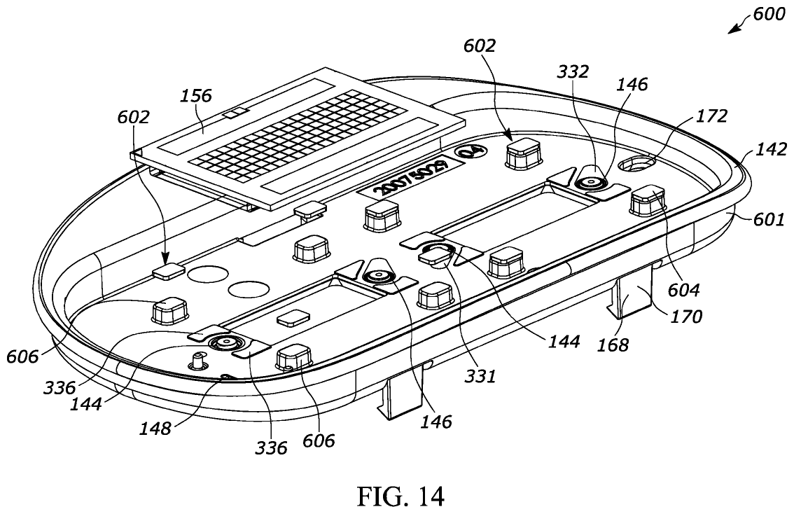

FIG. 14 is an expanded isometric view of an example implementation of a flow cell assembly 600 that can be used to implement the flow cell assembly 106 of FIG. 1. The flow cell assembly 600 of FIG. 14 is similar to the flow cell assembly 302 of FIG. 2. The flow cell assembly 600 of FIG. 14 includes a body 601 and the body 601 and the flow cell 156 are coupled by a coupling 602 that is different from the coupling 306 of the flow cell assembly 302 of FIG. 2. The coupling 602 of FIG. 14 includes tape 604. The tape 604 may be double sided foam tape. The body 601 is shown including pads 606 on which the tape 604 is positioned. The tape 604 allows for the flow cell 156 to be relatively fixed in the x-direction and/or the y-direction but allows the flow cell 156 to move in the z-direction when the tape 604 is implemented by double-sided tape as an example.

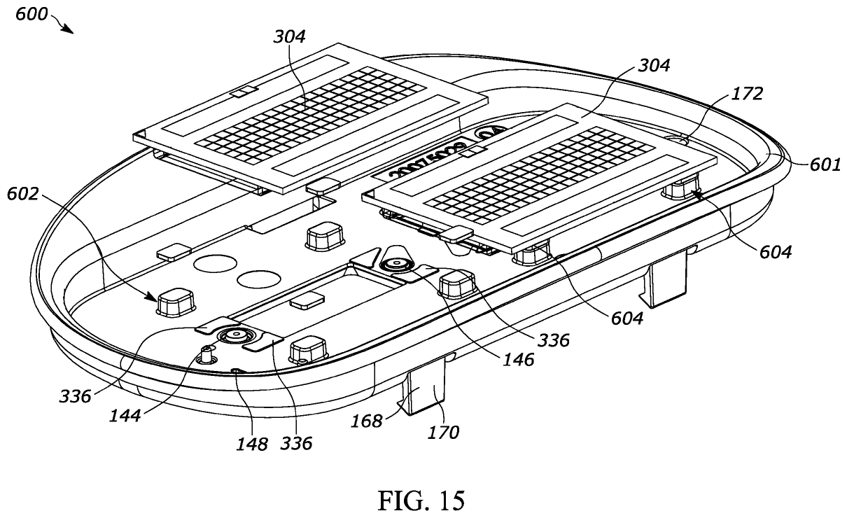

FIG. 15 is an expanded isometric view of an example implementation of the cell assembly 600 of FIG. 14. The flow cell assembly 600 includes one of the flow cells 156 shown being coupled to the body 601 by the coupling 602.

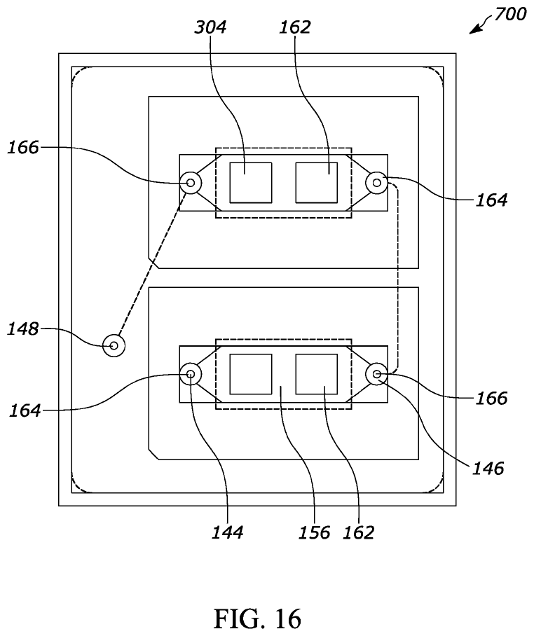

FIG. 16 is a plan view of an example implementation of a flow cell assembly 700 that can be used to implement the flow cell assembly 106 of FIG. 1. The flow cell assembly 700 includes the flow cell 156 and the second flow cell 304 that are fluidly coupled in series. The flow cell 156 and the second flow cell 304 have longitudinal axes that are substantially parallel to one another in the implementation shown. The arrangement of the flow cells 156, 304 may be referred to as a side-by-side configuration.

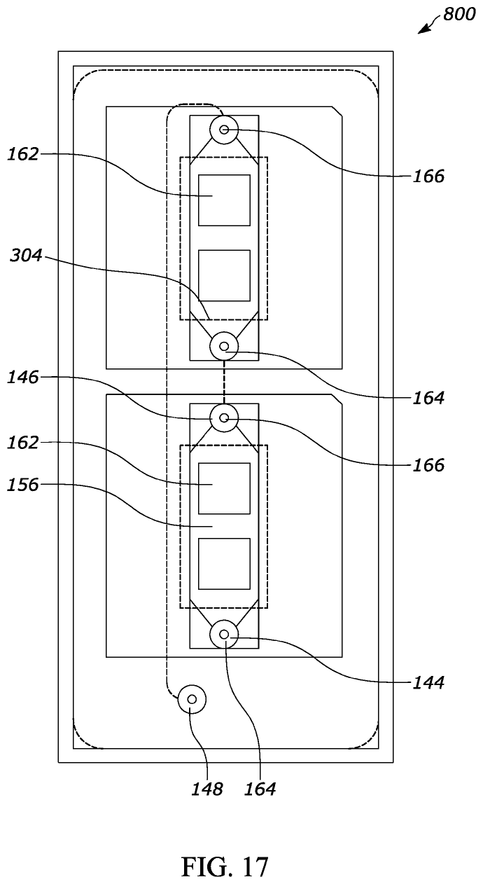

FIG. 17 is a plan view of an example implementation of a flow cell assembly 800 that can be used to implement the flow cell assembly 106 of FIG. 1. The flow cell assembly 800 includes the flow cell 156 and the second flow cell 304 that are fluidly coupled in series. The flow cell 156 and the second flow cell 304 have longitudinal axes that are substantially coaxial to one another. The arrangement of the flow cells 156, 304 may be referred to as an end-to-end vertical configuration. The end-to-end vertical configuration may be the position of the flow cells 156, 304 relative to the cartridge assembly 300 when the flow cells 156, 304 are coupled to the flow cell assembly 106.

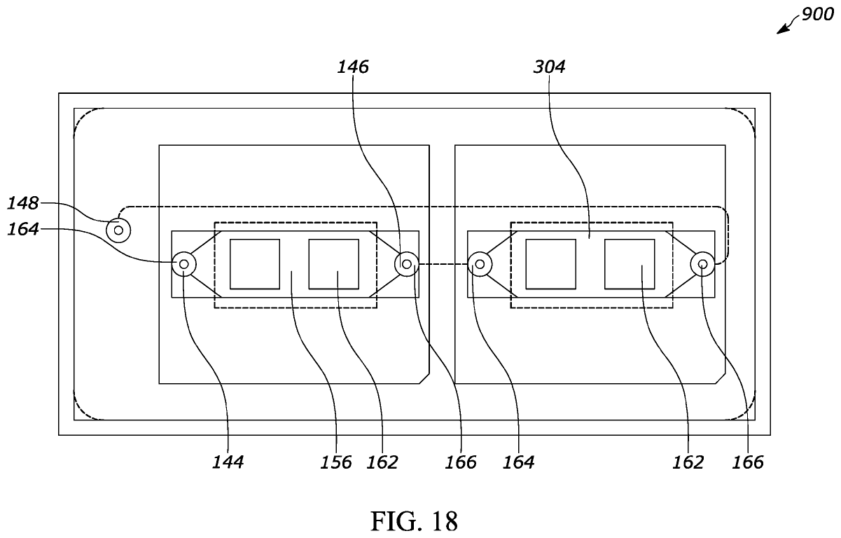

FIG. 18 is a plan view of an example implementation of a flow cell assembly 900 that can be used to implement the flow cell assembly 106 of FIG. 1. The flow cell assembly 900 includes the flow cell 156 and the second flow cell 304 that are fluidly coupled in series. The flow cell 156 and the second flow cell 304 have longitudinal axes that are substantially coaxial to one another. The arrangement of the flow cells 156, 304 may be referred to as an end-to-end horizontal configuration. The flow cell assembly 800 of FIG. 17 and the flow cell assembly 900 of FIG. 18 are substantially the same but the flow cell assembly 800 of FIG. 17 has the end-to-end vertical configuration and the flow cell assembly 900 of FIG. 18 has the end-to-end horizontal configuration. The end-to-end horizontal configuration may be the position of the flow cells 156, 304 relative to the cartridge assembly 300 when the flow cells 156, 304 are coupled to the flow cell assembly 106. The flow cells 156, 304 can be positioned in the end-to-end vertical configuration and/or the end-to-end horizontal configuration within the cartridge assemblies 104 and/or 300.

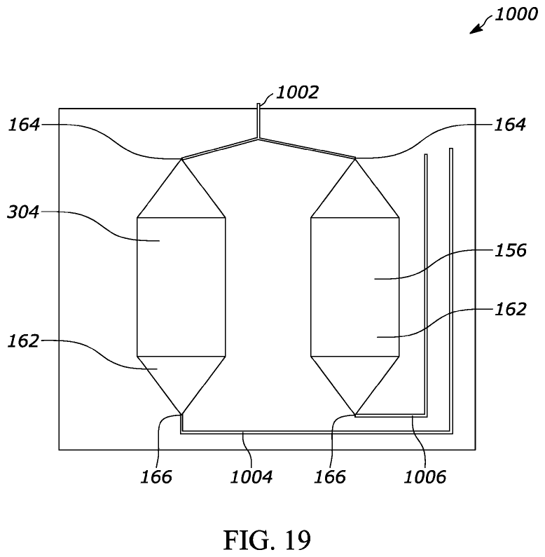

FIG. 19 is a plan view of an example implementation of a flow cell assembly 1000 that can be used to implement the flow cell assembly 106 of FIG. 1. The flow cell assembly 1000 includes the flow cell 156 and the second flow cell 304 that are fluidly coupled in parallel. The flow cell 156 and the second flow cell 304 have longitudinal axes that are substantially parallel to one another. The arrangement of the flow cells 156, 304 may be referred to as a side-by-side horizontal configuration.

The flow cell assembly 1000 includes a shared fluidic line 1002 on one side of the flow cells 156, 304 and separate fluidic lines 1004, 1006 on another side of the flow cells 156, 304. The shared fluidic line 1002 is shown fluidly coupled to the flow cell inlets 164 and the separate fluidic lines 1004, 1006 are shown fluidly coupled to the corresponding flow cell outlets 166. The shared fluidic line 1002 may be fluidly coupled to the flow cell outlets 166 and the separate fluidic lines 1004, 1006 may be fluidly coupled to the corresponding flow cell inlets 164, however. A sample of interest can be loaded into the flow cells 156, 304 from the rear of the flow cells 156, 304. Loading a sample of interest from the rear of the flow cells 156, 304 may be referred to as “back loading.” Back loading the sample of interest into the flow cells 156, 304 may reduce contamination.

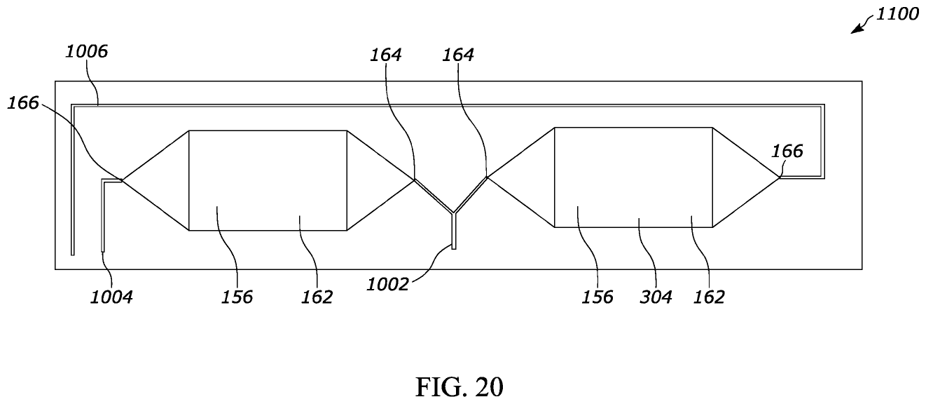

FIG. 20 is a plan view of an example implementation of a flow cell assembly 1100 that can be used to implement the flow cell assembly 106 of FIG. 1. The flow cell assembly 1000 includes the flow cell 156 and the second flow cell 304 that are fluidly coupled in parallel. The flow cell 156 and the second flow cell 304 thus have longitudinal axes that are substantially coaxial to one another. The shared fluidic line 1002 is shown fluidly coupled to the flow cell inlets 164 and the separate fluidic lines 1004, 1006 are shown fluidly coupled to the corresponding flow cell outlets 166. The arrangement of the flow cells 156, 304 may be referred to as an end-to-end configuration.

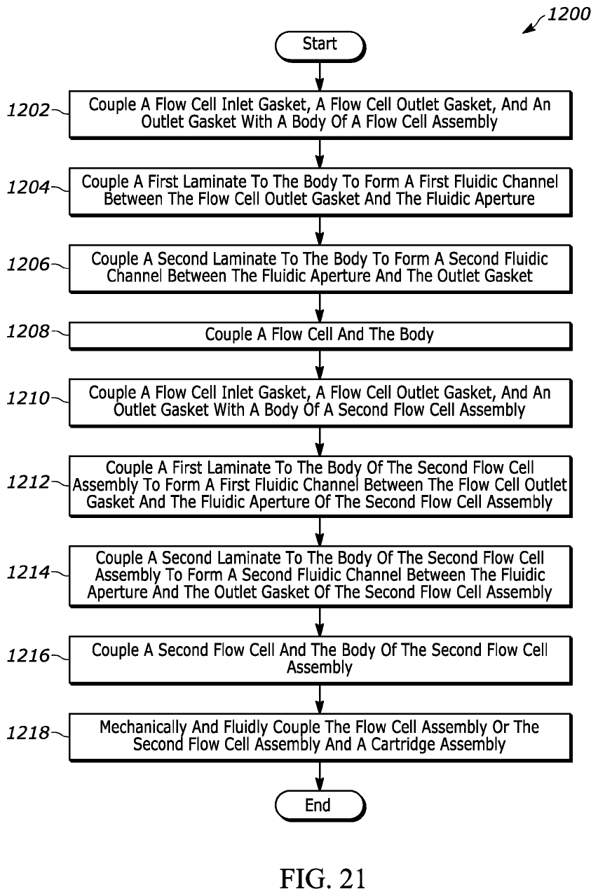

FIG. 21 illustrates a flow chart for a method of manufacturing the flow cell assemblies 106, 302, 400, 500, 600, 700, 800, 900, 1000, and/or 1100 of FIGS. 1-20 and/or the cartridge assemblies 104 and/or 300 of FIGS. 1-2 or any of the other implementations disclosed herein. The order of execution of the blocks may be changed, and/or some of the blocks described may be changed, eliminated, combined and/or subdivided into multiple blocks.

The process 1200 of FIG. 21 starts with coupling a flow cell inlet gasket 144, a flow cell outlet gasket 146, and an outlet gasket 148 with a body 142, 401, 501, 601 of a flow cell assembly 106, 302, 500, 600,700, 800, 900, 1000, 1100 (Block 1202). The gaskets 144, 146, 148 may be coupled with the body 142, 401, 501, 601 using a molding process such as a two-shot molding process. The gaskets 144, 146, 148 may be coupled with the body 142, 401, 501, 601 in different ways, however. The body 142, 401, 501, 601 has a fluidic aperture 150.

A first laminate 152 is coupled to the body 142, 401, 501, 601 to form a first fluidic channel 158 between the flow cell outlet gasket 146 and the fluidic aperture 150 (Block 1204) and a second laminate 154 is coupled to the body 142, 401, 501, 601 to form a second fluidic channel 160 between the fluidic aperture 150 and the outlet gasket 148 (Block 1206). A flow cell 156, 304, 404, 502 and the body 142, 401, 501, 601 are coupled (Block 1208). The flow cell 156, 304, 404, 502 and the body 142, 401, 501, 601 may be coupled using the coupling 306 including the snap-fit cantilevers 308, 310 and/or the coupling 602 including the tape 604. The flow cell 156, 304, 404, 502 has the channel 162 including the flow cell inlet 164 and the flow cell outlet 166, where the flow cell inlet 164 is fluidly coupled to the flow cell inlet gasket 144 and the flow cell outlet 166 is fluidly coupled to the flow cell outlet gasket 146.

The process of FIG. 21 also includes coupling a flow cell inlet gasket 144, a flow cell outlet gasket 146, and an outlet gasket 148 with a body 142, 401, 501, 601 of a second flow cell assembly 106, 302, 500, 600,700, 800, 900, 1000, 1100 (Block 1210). The body 142, 401, 501, 601 of the second flow cell assembly 106, 302, 500, 600,700, 800, 900, 1000, 1100 also has a fluidic aperture 150. The first laminate 152 is coupled to the body 142, 401, 501, 601 of the second flow cell assembly 106, 302, 500, 600,700, 800, 900, 1000, 1100 to form a first fluidic channel 158 between the flow cell outlet gasket 146 and the fluidic aperture 150 of the second flow cell assembly 106, 302, 500, 600,700, 800, 900, 1000, 1100 (Block 1212) and the second laminate 154 is coupled to the body 142, 401, 501, 601 of the second flow cell assembly 106, 302, 500, 600,700, 800, 900, 1000, 1100 to form the second fluidic channel 160 between the fluidic aperture 150 and the outlet gasket 148 of the second flow cell assembly 106, 302, 500, 600,700, 800, 900, 1000, 1100 (Block 1214). The second flow cell 156, 304, 404, 502 and the body 142, 401, 501, 601 of the second flow cell assembly 106, 302, 500, 600,700, 800, 900, 1000, 1100 are coupled (Block 1216). The flow cell 156, 304, 404, 502 and the second flow cell 156, 304, 404, 502 may be different. The flow cell 156, 304, 404, 502 and the second flow cell 156, 304, 404, 502 may and/or may include channels having different sizes, may include a different number of channels, may be different sizes, and/or may include a different number of sensors (e.g., one sensor versus two sensors). The flow cell 156, 304, 404, 502 may be longer as an example relative to the second flow cell 156, 304, 404, 502 (e.g., compare the flow cells of FIGS. 3 and 6). The flow cell assembly 106, 302, 500, 600,700, 800, 900, 1000, 1100 and/or the second flow cell assembly 106, 302, 500, 600,700, 800, 900, 1000, 1100 may carry one or more flow cells 156, 304, 404, 502 that may be the same or different (see FIGS. 3-7, 14-20).

The flow cell assembly 106, 302, 500, 600,700, 800, 900, 1000, 1100 or the second flow cell assembly 106, 302, 500, 600,700, 800, 900, 1000, 1100 and the cartridge assembly 104, 300 are mechanically and fluidly coupled (Block 1218). The flow cell assembly 106, 302, 500, 600,700, 800, 900, 1000, 1100 and the second flow cell assembly 106, 302, 500, 600,700, 800, 900, 1000, 1100 may be interchangeably mechanically and fluidly couplable with the cartridge assembly 104, 300. Different flow cell assemblies having one or more flow cells 156 of the same or different may be used with the cartridge assembly 104, 300 using the disclosed examples allowing for greater design flexibility and decreased cost while retaining the same or substantially the same mechanical footprint for the flow cell assemblies. The cartridge assembly 104, 300 includes the fluidic interface 132, the well 134, the channel 136 fluidly coupled between the fluidic interface 132 and the well 134, and the outlet port 138 fluidly coupled to the well 134 and to one of the flow cell assembly 106, 302, 500, 600,700, 800, 900, 1000, 1100 or the second flow cell assembly 106, 302, 500, 600,700, 800, 900, 1000, 1100.

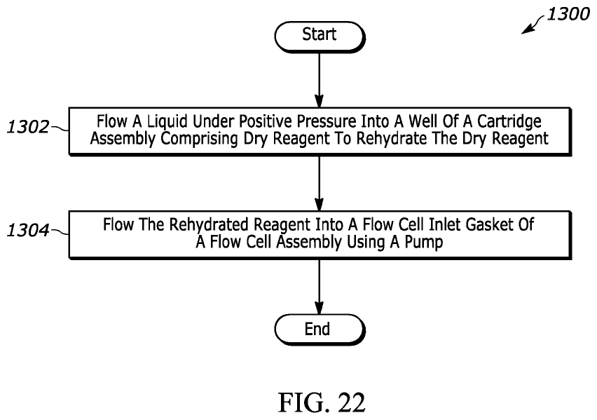

FIG. 22 illustrates a flow chart for a method of using the flow cell assemblies 106, 302, 400, 500, 600, 700, 800, 900, 1000, and/or 1100 of FIGS. 1-20 and/or the cartridge assemblies 104 and/or 300 of FIGS. 1-2 or any of the other implementations disclosed herein. The order of execution of the blocks may be changed, and/or some of the blocks described may be changed, eliminated, combined and/or subdivided into multiple blocks.

The process 1200 of FIG. 22 starts with flowing a liquid 203 under positive pressure into a well 134 of a cartridge assembly 104, 300 including dry reagent 178 to rehydrate the dry reagent 178 (Block 1302). The cartridge assembly 104, 300 includes the well 134 and an outlet port 138 fluidly coupled to the well 134. The liquid 203 being flowed under positive pressure includes using a gas source 114 in some implementations.

The rehydrated reagent 178 is pumped into the flow cell inlet gasket 144 of a flow cell assembly 106, 302, 400, 500, 600, 700, 800, 900, 1000, and/or 1100 using a pump 176 (Block 1304). The flow cell assembly 106, 302, 400, 500, 600, 700, 800, 900, 1000, and/or 1100 includes a body 142 carrying a flow cell inlet gasket 144 and a flow cell 156 supported by the body 142. The flow cell inlet gasket 144 is fluidly coupled to the outlet port 138 and the flow cell 156. The cartridge assembly 104, 300 may include the pump 176. The system 100 may alternatively include the pump 176. The pump 176 may include a syringe pump. The pump 176 is positioned upstream of the flow cell 156 in some implementations. The pump 176 is positioned downstream of the flow cell 156 in other implementations. The liquid 203 may be flowed under positive pressure into the well 134 by pressurizing a storage chamber 126 of a reagent reservoir 102 including the liquid 203 and flowing the liquid 203 from the storage chamber 126 to the cartridge assembly 104, 300.

Example 1. An apparatus comprising: a system, comprising: a pneumatic interface; and a receptacle; a liquid reservoir receivable within the receptacle and having: a body comprising a storage chamber, a pneumatic port fluidly couplable to the storage chamber, and a fluidic port fluidly coupled to the storage chamber and a cartridge assembly, comprising: a fluidic interface couplable to the fluidic port; a well; a channel fluidly coupled between the fluidic interface and the well; and an outlet port fluidly coupled to the well; and a flow cell assembly, comprising: a body carrying a flow cell inlet gasket, a flow cell outlet gasket, and an outlet gasket, the body comprising a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket, wherein the outlet port is fluidly coupled to the flow cell inlet gasket.

Example 2. The apparatus of example 1, wherein the flow cell assembly is coupled to the cartridge assembly by a coupling.

Example 3. The apparatus of example 2, wherein the coupling comprises a snap fit connection.

Example 4. The apparatus of any one of the preceding examples, wherein the cartridge assembly comprises a pair of locating posts and the body of the flow cell assembly comprises a pair of locating holes that register with the corresponding locating posts.

Example 5. The apparatus of any one of the preceding examples, wherein the cartridge assembly comprises a pump coupled to at least one of the outlet gasket of the flow cell assembly or between the well and the flow cell assembly.

Example 6. The apparatus of example 5, wherein the pump comprises a syringe pump.

Example 7. The apparatus of any one of examples 5-6, further comprising dried reagent contained within the well and wherein the syringe pump is used to flow rehydrated dried reagent from the well to the flow cell.

Example 8. The apparatus of any one of the preceding examples, wherein the body comprises a first groove and a second groove, the first laminate covering the first groove to form the first fluidic channel and the second laminate covering the second groove to form the second fluidic channel.

Example 9. An apparatus, comprising: a cartridge assembly, comprising: a fluidic interface; a well; a channel fluidly coupled between the fluidic interface and the well; and an outlet port fluidly coupled to the well; and a flow cell assembly, comprising: a body carrying a flow cell inlet gasket, a flow cell outlet gasket, and an outlet gasket, the body comprising a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket, wherein the outlet port is fluidly coupled to the flow cell inlet gasket.

Example 10. The apparatus of example 9, wherein the flow cell assembly comprises a second flow cell supported by the body.

Example 11. The apparatus of example 10, wherein the flow cell and the second flow cell are fluidly coupled in series.

Example 12. The apparatus of any one of examples 10-11, wherein the flow cell outlet of the flow cell is fluidly coupled to the flow cell outlet gasket via the second flow cell.

Example 13. The apparatus of any one of examples 10-12, wherein the body of the flow cell assembly and the second flow cell are coupled by a coupling.

Example 14. The apparatus of any one of examples 9-13, wherein the body of the flow cell assembly and the flow cell are coupled by a coupling.

Example 15. The apparatus of example 14, wherein the coupling comprises a first snap-fit cantilever and a second snap-fit cantilever, the first snap-fit cantilever positioned on a first side of the flow cell and the second snap-fit cantilever positioned on a second side of the flow cell.

Example 16. The apparatus of example 15, wherein the first snap-fit cantilever biases the flow cell in the x-direction and the second snap-fit cantilever biases the flow cell in the y-direction.

Example 17. The apparatus of any one of examples 14-16, wherein the coupling comprises a pair of hold downs comprising a lip to be positioned overtop of the flow cell.

Example 18. The apparatus of example 17, wherein both of the hold downs are positioned on a side of the flow cell.

Example 19. The apparatus of any one of examples 14-18, wherein the coupling comprises a x-datum projection and a y-datum projection against which the flow cell engages.

Example 20. The apparatus of example 19, further comprising a second x-datum projection.

Example 21. The apparatus of any one of examples 9-20, further comprising a second flow cell assembly comprising a second flow cell different than the flow cell, the second flow cell assembly couplable to the cartridge assembly in place of the flow cell assembly.

Example 22. The apparatus of example 21, further comprising a third flow cell assembly comprising a third flow cell and a fourth flow cell, the third flow cell assembly couplable to the cartridge assembly in place of the flow cell assembly and in place of the second flow cell assembly.

Example 23. An apparatus, comprising: a flow cell assembly, comprising: a body carrying a flow cell inlet gasket, a flow cell outlet gasket, and an outlet gasket, the body comprising a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket.

Example 24. The apparatus of example 23, wherein the flow cell assembly comprises a second flow cell supported by the body.

Example 25. The apparatus of example 24, wherein the flow cell and the second flow cell are fluidly coupled in series.

Example 26. The apparatus of any one of examples 24-25, wherein the body carries a second flow cell inlet gasket and a second flow cell outlet gasket, the second flow cell comprising a channel comprising a flow cell inlet and a flow cell outlet, the flow cell inlet of the second flow cell fluidly coupled to the second flow cell inlet gasket and the flow cell outlet of the second flow cell fluidly coupled to the second flow cell outlet gasket.

Example 27. The apparatus of example 26, wherein the second laminate forms the second fluidic channel between the second flow cell outlet gasket and the outlet gasket.

Example 28. The apparatus of any one of examples 26-27, further comprising a third fluidic channel between the flow cell outlet gasket and the second flow cell inlet gasket.

Example 29. The apparatus of example 28, wherein the second laminate forms the third fluidic channel.

Example 30. The apparatus of examples 28-29, wherein the body comprises a first groove, a second groove, and a third groove, the first laminate covering the first groove to form the first fluidic channel and the third groove to form the third fluidic channel and the second laminate covering the second groove to form the second fluidic channel.

Example 31. The apparatus of example 23-30, wherein the body comprises locating posts and the second laminate comprises locating holes that receive the corresponding locating posts.

Example 32. The apparatus of any one of examples 23-31, wherein the body defines a window to allow visual access of the flow cell.

Example 33. The apparatus of any one of examples 23-32, wherein the body comprise locating posts and the first laminate comprises locating holes that receive the corresponding locating posts.

Example 34. The apparatus of any of examples 23-33, wherein the body comprises a plurality of first pads and a plurality of second pads, the first pads opposing the second pads.

Example 35. The apparatus of example 34, wherein the flow cell rests on the first pads.

Example 36. The apparatus of any one of examples 33-35, wherein the body defines a window to allow visual access of the flow cell, the window comprising corners, and wherein the first pads and the second pads are located adjacent the corresponding corners.

Example 37. The apparatus of any one of examples 23-36, wherein the body of the flow cell assembly and the flow cell are coupled by a coupling.

Example 38. The apparatus of example 37, wherein the coupling comprises tape.

Example 39. The apparatus of any one of examples 23-38, wherein the flow cell assembly comprises a second flow cell supported by the body.

Example 40. The apparatus of example 39, wherein the flow cell and the second flow cell are fluidly coupled in series.

Example 41. The apparatus of example 40, wherein the flow cell and the second flow cell have longitudinal axes that are substantially parallel to one another.

Example 42. The apparatus of example 40, wherein the flow cell and the second flow cell have longitudinal axes that are substantially coaxial.

Example 43. The apparatus of example 39, wherein the flow cell and the second flow cell are fluidly coupled in parallel.

Example 44. The apparatus of example 43, wherein the flow cell and the second flow cell have longitudinal axes that are substantially parallel to one another.

Example 45. The apparatus of example 43, wherein the flow cell and the second flow cell have longitudinal axes that are substantially coaxial.

Example 46. A method comprising, comprising: coupling a flow cell inlet gasket, a flow cell outlet gasket, and an outlet gasket with a body of a flow cell assembly, the body comprising a fluidic aperture; coupling a first laminate to the body and forming a first fluidic channel between the flow cell outlet gasket and the fluidic aperture; coupling a second laminate to the body to form a second fluidic channel between the fluidic aperture and the outlet gasket; and coupling a flow cell and the body, the flow cell comprising a channel comprising a flow cell inlet and a flow cell outlet, the flow cell inlet fluidly coupled to the flow cell inlet gasket and the flow cell outlet fluidly coupled to the flow cell outlet gasket.

Example 47. The method of example 46, further comprising: coupling a flow cell inlet gasket, a flow cell outlet gasket, and an outlet gasket with a body of a second flow cell assembly, the body of the second flow cell assembly comprising a fluidic aperture; coupling a first laminate to the body of the second flow cell assembly to form a first fluidic channel between the flow cell outlet gasket and the fluidic aperture of the second flow cell assembly; coupling a second laminate to the body of the second flow cell assembly to form a second fluidic channel between the fluidic aperture and the outlet gasket of the second flow cell assembly; and coupling a second flow cell and the body of the second flow cell assembly.

Example 48. The method of example 47, wherein the flow cell and the second flow cell are different.

Example 49. The method of any one of examples 47-48, further comprising mechanically and fluidly coupling the flow cell assembly or the second flow cell assembly and a cartridge assembly.

Example 50. The method of example 49, wherein the flow cell assembly and the second flow cell assembly are interchangeably mechanically and fluidly couplable with the cartridge assembly.

Example 51. The method of any one of examples 49-50, wherein the cartridge assembly, comprising: a fluidic interface; a well; a channel fluidly coupled between the fluidic interface and the well; and an outlet port fluidly coupled to the well and to one of the flow cell assembly or the second flow cell assembly.

Example 52. An apparatus, comprising: a cartridge assembly; and a first flow cell assembly including a first flow cell; and a second flow cell assembly including a second flow cell different than the first flow cell, wherein the first flow cell assembly and the second flow cell assembly are interchangeably mechanically and fluidly couplable with the cartridge assembly.

Example 53. An apparatus, comprising: a cartridge assembly; and a first flow cell assembly including a single cell; and a second flow cell assembly including a pair of flow cells, wherein the first flow cell assembly and the second flow cell assembly are interchangeably mechanically and fluidly couplable with the cartridge assembly.

Example 54. A method, comprising: flowing a liquid under positive pressure into a well of a cartridge assembly comprising dry reagent to rehydrate the dry reagent, the cartridge assembly comprising the well and an outlet port fluidly coupled to the well; and flowing the rehydrated reagent into a flow cell inlet gasket of a flow cell assembly using a pump, the flow cell assembly comprising a body carrying the flow cell inlet gasket and a flow cell supported by the body, the flow cell inlet gasket fluidly coupled to the outlet port and the flow cell.

Example 55. The method of example 54, wherein flowing the liquid under positive pressure comprises using a gas source.

Example 56. The method of any one of examples 54-55, wherein the cartridge assembly comprises the pump.

Example 57. The method of any one of examples 54-56, wherein the pump comprises a syringe pump.

Example 58. The method of any one of examples 54-57, wherein the pump is positioned upstream of the flow cell.

Example 59. The method of any one of examples 54-57, wherein the pump is positioned downstream of the flow cell.

Example 60. The method of any one of examples 54-59, wherein flowing the liquid under positive pressure into the well comprises pressurizing a storage chamber of a reagent reservoir comprising the liquid and flowing the liquid from the storage chamber to the cartridge assembly.

Example 61. The method of any one of examples 54-60, wherein the flow cell assembly comprises the body carrying the flow cell inlet gasket, a flow cell outlet gasket, and an outlet gasket, the body comprising a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and the flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket.

Example 62. A method comprising:
flowing a reagent through the flow cell assembly of any one of examples 1-45.

Example 63. The apparatus of example 1, wherein the cartridge assembly comprises a pump coupled to at least one of the outlet gasket of the flow cell assembly or between the well and the flow cell assembly.

Example 64. The apparatus of example 63, wherein the pump comprises a syringe pump.

Example 65. The apparatus of example 63, further comprising dried reagent contained within the well and wherein the syringe pump is used to flow rehydrated dried reagent from the well to the flow cell.

Example 66. The apparatus of example 1, wherein the body comprises a first groove and a second groove, the first laminate covering the first groove to form the first fluidic channel and the second laminate covering the second groove to form the second fluidic channel.

Example 67. The apparatus of example 9, wherein the body of the flow cell assembly and the flow cell are coupled by a coupling.

Example 68. The apparatus of example 67, wherein the coupling comprises a first snap-fit cantilever and a second snap-fit cantilever, the first snap-fit cantilever positioned on a first side of the flow cell and the second snap-fit cantilever positioned on a second side of the flow cell.

Example 69. The apparatus of example 68, wherein the first snap-fit cantilever biases the flow cell in the x-direction and the second snap-fit cantilever biases the flow cell in the y-direction.

Example 70. The apparatus of example 9, wherein the coupling comprises a pair of hold downs comprising a lip to be positioned overtop of the flow cell.

Example 71. The apparatus of example 9, further comprising a second flow cell assembly comprising a second flow cell different than the flow cell, the second flow cell assembly couplable to the cartridge assembly in place of the flow cell assembly.

Example 72. The apparatus of example 23, wherein the body comprises locating posts and the second laminate comprises locating holes that receive the corresponding locating posts.

Example 73. The apparatus of example 23, wherein the body defines a window to allow visual access of the flow cell.

Example 74. The apparatus of example 23, wherein the body comprise locating posts and the first laminate comprises locating holes that receive the corresponding locating posts.

Example 75. The apparatus of example 23, wherein the body comprises a plurality of first pads and a plurality of second pads, the first pads opposing the second pads.

Example 76. The apparatus of example 75, wherein the flow cell rests on the first pads.

Example 77. The method of example 54, wherein the pump comprises a syringe pump.

Example 78. The method of example 54, wherein the pump is positioned upstream of the flow cell.

Example 79. The method of example 54, wherein the pump is positioned downstream of the flow cell.

Example 80. The method of example 54, wherein flowing the liquid under positive pressure into the well comprises pressurizing a storage chamber of a reagent reservoir comprising the liquid and flowing the liquid from the storage chamber to the cartridge assembly.

Example 81. The method of example 54, wherein the flow cell assembly comprises the body carrying the flow cell inlet gasket, a flow cell outlet gasket, and an outlet gasket, the body comprising a fluidic aperture; a first laminate coupled to the body and forming a first fluidic channel between the flow cell outlet gasket and the fluidic aperture; a second laminate coupled to the body and forming a second fluidic channel between the fluidic aperture and the outlet gasket; and the flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

While cartridges and reservoirs are described herein with regard to reagent cartridges and reagent reservoirs, these cartridges or reservoirs may also be used to house other liquids, including without limitation buffers, samples, and washes, either separate from or in combination with reagents or other liquids. For example, a cartridge may have a first chamber housing a reagent, a second chamber housing a buffer, and a third chamber housing a wash. Furthermore, the cartridges and reservoirs described herein may include one or more additional chambers that may be used, for example, as waste chambers on the cartridge that may or may not include corresponding sipper chambers.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The terms “connect,” “connected,” “contact,” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus comprising:
a system, comprising:
a pneumatic interface; and
a receptacle;
a liquid reservoir receivable within the receptacle and having:
a body comprising a storage chamber, a pneumatic port fluidly couplable to the storage chamber, and a fluidic port fluidly coupled to the storage chamber and
a cartridge assembly, comprising:
a fluidic interface couplable to the fluidic port;
a well;
a channel fluidly coupled between the fluidic interface and the well; and
an outlet port fluidly coupled to the well; and
a flow cell assembly, comprising:
a body carrying a flow cell inlet gasket, a flow cell outlet gasket, and an outlet gasket, the body comprising a fluidic aperture;
a first laminate coupled to the body and forming a first fluidic channel between the flow cell outlet gasket and the fluidic aperture;
a second laminate coupled to the body and forming a second fluidic channel between the fluidic aperture and the outlet gasket; and
a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket,
wherein the outlet port is fluidly coupled to the flow cell inlet gasket.

2. The apparatus of claim 1, wherein the flow cell assembly is coupled to the cartridge assembly by a coupling, wherein the coupling comprises a snap fit connection.

3. (canceled)

4. The apparatus of claim 1, wherein the cartridge assembly comprises a pair of locating posts and the body of the flow cell assembly comprises a pair of locating holes that register with the corresponding locating posts.

5-8. (canceled)

9. An apparatus, comprising:
a cartridge assembly, comprising:
a fluidic interface;
a well;
a channel fluidly coupled between the fluidic interface and the well; and
an outlet port fluidly coupled to the well; and
a flow cell assembly, comprising:
a body carrying a flow cell inlet gasket, a flow cell outlet gasket, and an outlet gasket, the body comprising a fluidic aperture;
a first laminate coupled to the body and forming a first fluidic channel between the flow cell outlet gasket and the fluidic aperture;
a second laminate coupled to the body and forming a second fluidic channel between the fluidic aperture and the outlet gasket; and
a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket,
wherein the outlet port is fluidly coupled to the flow cell inlet gasket.

10. The apparatus of claim 9, wherein the flow cell assembly comprises a second flow cell supported by the body.

11. The apparatus of claim 10, wherein the flow cell and the second flow cell are fluidly coupled in series.

12. The apparatus of claim 10, wherein the flow cell outlet of the flow cell is fluidly coupled to the flow cell outlet gasket via the second flow cell.

13-22. (canceled)

23. An apparatus, comprising:
a flow cell assembly, comprising:
a body carrying a flow cell inlet gasket, a flow cell outlet gasket, and an outlet gasket, the body comprising a fluidic aperture;
a first laminate coupled to the body and forming a first fluidic channel between the flow cell outlet gasket and the fluidic aperture;
a second laminate coupled to the body and forming a second fluidic channel between the fluidic aperture and the outlet gasket; and
a flow cell supported by the body and comprising a channel comprising a flow cell inlet and a flow cell outlet, the flow cell inlet fluidly coupled to the flow cell inlet gasket and the flow cell outlet fluidly coupled to the flow cell outlet gasket.

24. The apparatus of claim 23, wherein the flow cell assembly comprises a second flow cell supported by the body.

25. The apparatus of claim 24, wherein the flow cell and the second flow cell are fluidly coupled in series.

26. The apparatus of claim 24, wherein the body carries a second flow cell inlet gasket and a second flow cell outlet gasket, the second flow cell comprising a channel comprising a flow cell inlet and a flow cell outlet, the flow cell inlet of the second flow cell fluidly coupled to the second flow cell inlet gasket and the flow cell outlet of the second flow cell fluidly coupled to the second flow cell outlet gasket, wherein the second laminate forms the second fluidic channel between the second flow cell outlet gasket and the outlet gasket.

27-62. (canceled)

63. The apparatus of claim 1, wherein the cartridge assembly comprises a pump coupled to at least one of the outlet gasket of the flow cell assembly or between the well and the flow cell assembly.

64. The apparatus of claim 63, wherein the pump comprises a syringe pump, further comprising dried reagent contained within the well and wherein the syringe pump is used to flow rehydrated dried reagent from the well to the flow cell.

65. (canceled)

66. The apparatus of claim 1, wherein the body comprises a first groove and a second groove, the first laminate covering the first groove to form the first fluidic channel and the second laminate covering the second groove to form the second fluidic channel.

67. The apparatus of claim 9, wherein the body of the flow cell assembly and the flow cell are coupled by a coupling, wherein the coupling comprises a first snap-fit cantilever and a second snap-fit cantilever, the first snap-fit cantilever positioned on a first side of the flow cell and the second snap-fit cantilever positioned on a second side of the flow cell, wherein the first snap-fit cantilever biases the flow cell in the x-direction and the second snap-fit cantilever biases the flow cell in the y-direction.

68. (canceled)

69. (canceled)

70. The apparatus of claim 9, wherein the coupling comprises a pair of hold downs comprising a lip to be positioned overtop of the flow cell.

71. (canceled)

72. The apparatus of claim 23, wherein the body comprises locating posts and the second laminate comprises locating holes that receive the corresponding locating posts.

73. The apparatus of claim 23, wherein the body defines a window to allow visual access of the flow cell.

74. The apparatus of claim 23, wherein the body comprise locating posts and the first laminate comprises locating holes that receive the corresponding locating posts.

75. The apparatus of claim 23, wherein the body comprises a plurality of first pads and a plurality of second pads, the first pads opposing the second pads, wherein the flow cell rests on the first pads.

76-81. (canceled)
